(19) United States
(12) Patent Application Publication
(10) Pub. No.: US 2006/0102001 A1
(43) Pub. Date: May 18, 2006

(54) Wet type air cleaner

(75) Inventor: Seung Hoon Shin, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/269,622

(22) Filed: Nov. 9, 2005

(30) Foreign Application Priority Data
Nov. 17, 2004 (KR) 10-2004-0094305
Dec. 6, 2004 (KR) 10-2004-0102007

(51) Int. Cl. B01D 47/00

(52) U.S. Cl. 96/283

(57) ABSTRACT

A wet type air cleaner includes a housing storing cleaning water in a bottom portion thereof, a blower unit for dispersing the cleaning water and allowing air to be introduced through the air suction port into the housing and to pass through the dispersed cleaning water, a guide block for guiding the air introduced through the air suction port toward the cleaning water stored in the bottom portion of the housing, and a pumping unit for supplying the cleaning water stored in the bottom portion of the housing to the blower unit to be dispersed thereby. The air cleaner further includes a first purification unit and a second purification unit. The blower unit and the first and the second purification unit are fixed on a same rotation shaft and rotated therewith.

### FIELD OF THE INVENTION

The present invention relates to an air cleaner; and, more particularly, to a wet type air cleaner with a simplified structure capable of efficiently removing foreign materials from indoor air suctioned into a housing of the air cleaner by allowing the air to be subject to multiple purification states.

### BACKGROUND OF THE INVENTION

In general, an air cleaner serves to purify indoor air containing fine dusts, various noxious gases, various germs, molds, viruses, etc., by using a purification medium. Such an air cleaner can be used through all seasons because it has various functions of removing unpleasant odors and small particles such as ticks, pollen and furs of pets, preventing an outbreak of disease due to an aerial infection, and so forth as well as its principal function of maintaining indoor air clean and pleasant.

Air cleaners can be largely classified into two types: dry type and wet type. Dry type air cleaners can be divided again into a filter type and an electric dust collection type.

Here, the electric dust collection type uses no filter, so it has a merit in that there is no need to replace filters. However, if dusts are accumulated on an electric dust collecting plate, purifying efficiency of the air cleaner will be deteriorated, and dust removing capacity thereof will also be undermined.

As for the filter type air cleaner, on the other hand, since various fine particles are captured while air passes through filters, the filter type air cleaner exhibits a high purifying efficiency, and thus is adequate for use in a season when yellow dust comes. However, since the filters need to be replaced periodically, maintenance cost thereof is high.

Meanwhile, a wet type air cleaner employs a method for making floating particles in suctioned air deposited in water by allowing the suctioned air to contact water. Though the wet type air cleaner has not been commonly utilized yet, it has many advantages in that it does not requires a replacement of filters and generates little noise, while providing a humidifying function as well. Thus, for children, its use is preferred. However, when using the wet type air cleaner, water should be replaced or replenished, which would be rather cumbersome.

FIG. 1 shows an exemplary configuration of a conventional wet type air cleaner disclosed in Korean Patent No. 10-0205566, entitled “Air cleaner”.

As shown in FIG. 1, a water filter 12 is installed at an air suction port 11. The water filter 12 removes dusts or germs from air passing therethrough, while releasing minerals. A water drain outlet of the water filter 12 is connected to a water tank 19, and a water tray 13 disposed at an upper side of the water filter 12 is connected to a water pump 22 via a water supply line 23. The water pump 22 is connected via a connection line 21 to the water tank 19 or a water supply unit 24 to pump up water into the water tray 13 of the water filter 12. A water supply valve 25 is installed on the connection line 21, and the water supply valve 25 is electrically connected to a controller 29 to be opened or closed under the control of the controller 29.

Moreover, a float switch 26 is provided in the water tank 19, and a water drain valve 27 is installed on a wastewater exhaust line 28. The float switch 26 and the water drain valve 27 are also connected to the controller 29 electrically.

An air suction fan 18 is installed on the side of a rear discharge port 16 of the water filter 12, and the fan 28 is rotated by a motor 17 to suck in air through the air suction port. The motor 17 is coupled to a motor driving circuit 30 connected with the controller 29.

Also, the water tray 18 and a collection tray 14 are disposed at an upper and a lower side of the water filter 12, respectively, and a number of water plates 15 are slantingly laminated between the water tray 18 and the collection tray 14 at regular intervals.

The conventional air cleaner configured as described above removes noxious substances such as dusts or germs from the air by using the water filter, and discharges minerals beneficial for human body.

However, in the conventional wet type air cleaner, the time period for the air to contact cleaning water is limited to a time period for the air to pass through the filter. As a result, the time during which the cleaning water adsorbs noxious substances from the air is not long, so that the efficiency for purifying the air cannot be improved over a certain level.

Besides, since the conventional wet type air cleaner has a complicated structure and a great number of components, time and costs for the fabrication of the air cleaner cannot be reduced, which is a limiting factor in reducing the price of the air cleaner.

In order to solve the above-mentioned problems, there is suggested a wet type air cleaner having a simple structure in which cleaning water is stored in a certain space, and a blower unit and a water spray unit are installed in a same space. One of such wet type air cleaners is disclosed in Japanese Patent Laid-open Publication No. 2000-334240, entitled “WET TYPE AIR CLEANER”.

The wet type air cleaner includes an air circulation passage through which air is introduced into the inside of the air cleaner and then is outputted to the outside after being purified. A reservoir containing therein liquid to be sprayed is formed in a part of the air circulation passage. The air cleaner further includes a blower unit for allowing the air to be circulated through the air circulation passage and a spray unit for spraying the liquid into a spray space in the reservoir.

The blower unit includes a fan for suctioning the air into the spray space and a motor for driving the fan. The spray unit includes a pump for pumping up the liquid from the reservoir and a nozzle for spraying the liquid into the spray space.

Further, the air supplied into the air circulation passage typically flows downward after being introduced into the reservoir from upside, whereas the liquid is sprayed upward from downside. Therefore, the air introduced into the reservoir is brought into contact with fine liquid particles sprayed by the nozzle, thereby allowing noxious substances in the air to be adsorbed by the liquid.

In the conventional wet type air cleaner as described above, however, the blower unit for circulating the indoor air and the spray unit for spraying the liquid are installed individually. Therefore, the number of components of the air cleaner cannot be reduced below a certain level.

Besides, in the conventional wet type air cleaner, droplets adsorbing fine dust are discharged to the outside together with the air, thereby resulting in a poor purification efficiency and an unexpected high humidity. Moreover, the contact between the cleaning water and the air is insufficient, so that the purification ability thereof is deteriorated.

### SUMMARY OF THE INVENTION

It is, therefore, an object of the present invention to provide a wet type air cleaner having a simplified structure capable of efficiently removing noxious substances from indoor air suctioned into a housing of the air cleaner by allowing the air to contact cleaning water stored in the housing and increasing the number of contact between the air and the cleaning water by means of multiple purification units.

In accordance with the present invention, there is provided a wet type air cleaner including: a housing with an air inlet port and an air outlet, the housing storing cleaning water in a bottom portion thereof; a blower unit for dispersing the cleaning water and allowing air to be introduced through the air inlet port into the housing and to pass through the dispersed cleaning water, the blower unit being fixed on a rotation shaft to be rotated therewith; a guide block for guiding the air introduced through the air inlet port toward the cleaning water stored in the bottom portion of the housing; a pumping unit for supplying the cleaning water stored in the bottom portion of the housing to the blower unit to be dispersed thereby.

Preferably, the air cleaner further includes a first purification unit for collecting and dispersing moisture contained in the air introduced through the air inlet port.

The first purification unit includes a drum fixed on the rotation shaft, the drum having a plurality of holes; and a collecting member for collecting moisture in the air introduced through the air inlet port into the drum.

Preferably, the air cleaner further includes a second purification unit installed on the rotation shaft, the second purification unit drawing up and dispersing the cleaning water stored in the bottom portion of the housing and directing the air introduced through the air inlet port to flow through the dispersed cleaning water into the cleaning water stored in the bottom portion of the housing.

The second purification unit includes an inner guide portion whose bottom end is submerged in the cleaning water; a water spray portion provided on the upper end of the inner guide portion; a fan for directing the air in the guide block downward; and an outer guide portion installed outside the inner guide portion with a gap formed therebetween to guide the air directed downward by the fan and the dispersed cleaning water into the cleaning water stored in the bottom portion of the housing, the inner guide portion having a wider upper portion and a narrower lower portion such that the cleaning water is drawn upward by a centrifugal force while it rotates.

The pumping unit includes a water supply line whose lower end is located in the cleaning water and whose upper end is positioned above the blower unit; and a pump installed on the water supply line to pump up the cleaning water stored in the bottom portion of the housing so that the cleaning water is supplied onto the blower unit.

Preferably, the air cleaner further includes a filter unit, disposed between the air outlet and the blower unit, for preventing the cleaning water dispersed by the blower unit from being discharged through the air outlet together with the air.

Preferably, the guide block is formed in a cylindrical shape with an opened bottom end portion, the guide block having a diameter smaller than that of the housing, and an air inlet is formed on a top end portion of the guide block, the air inlet extending radially to the outside of the housing through the suction air port of the housing, so that the air is introduced through the air inlet into the housing.

The guide block may have an opened bottom end portion which is submerged in the cleaning water stored in the bottom portion of the housing, and a plurality of holes may be formed in the bottom end portion.

### BRIEF DESCRIPTION OF THE DRAWINGS

The above and other objects and features of the present invention will become apparent from the following description of preferred embodiments given in conjunction with the accompanying drawings, in which:

FIG. 1 illustrates a conventional wet type air cleaner;

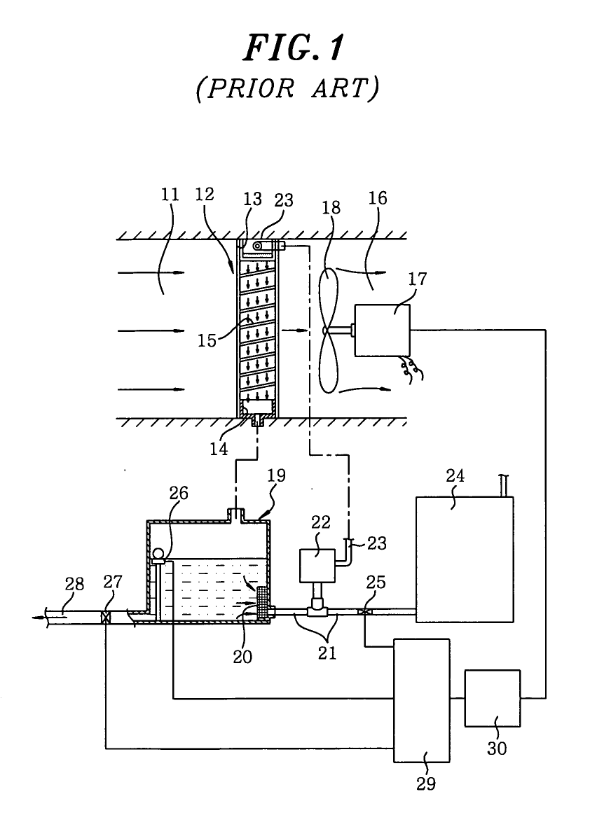

FIG. 2 sets forth a cross sectional view of a wet type air cleaner in accordance with a first preferred embodiment of the present invention;

FIG. 3 provides a perspective view of a guide block of the wet type air cleaner in FIG. 2;

FIG. 4 presents a cross sectional view of a second purification unit of the wet type air cleaner in accordance with the present invention;

FIG. 5 depicts a cross sectional view of a wet type air cleaner in accordance with a second preferred embodiment of the present invention;

FIG. 6 shows a perspective view of a guide block of the wet type air cleaner in FIG. 5; and

FIG. 7 is a cross sectional view of a wet type air cleaner in accordance with a modification of the second preferred embodiment of the present invention.

### DETAILED DESCRIPTION OF THE PREFERRED EMBODIMENTS

Hereinafter, a wet type air cleaner in accordance with preferred embodiments of the present invention will be described in detail with reference to the accompanying drawings.

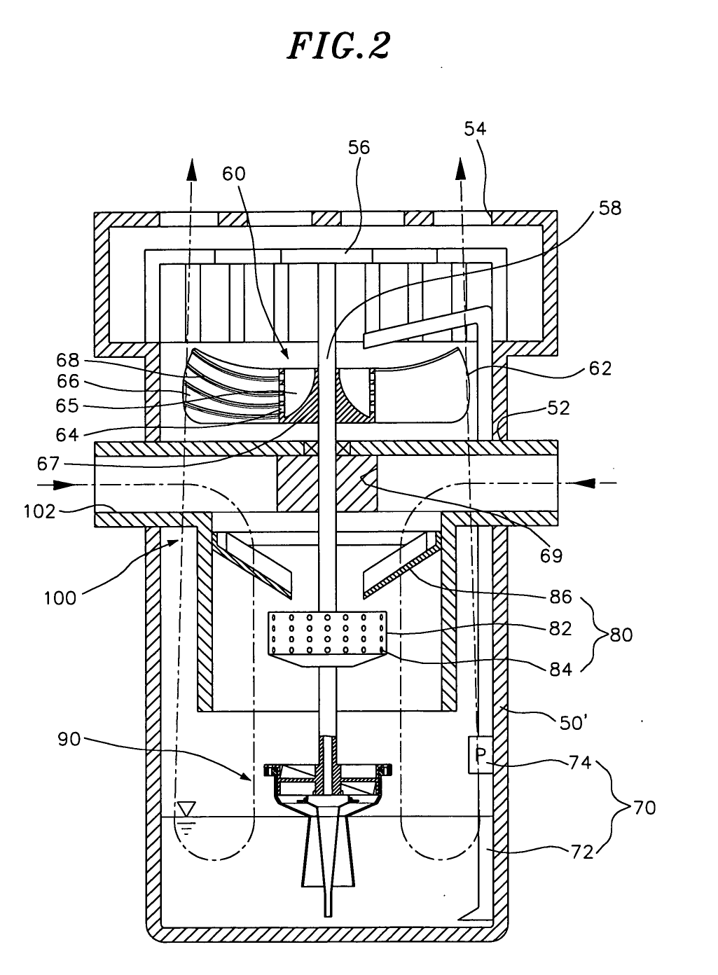

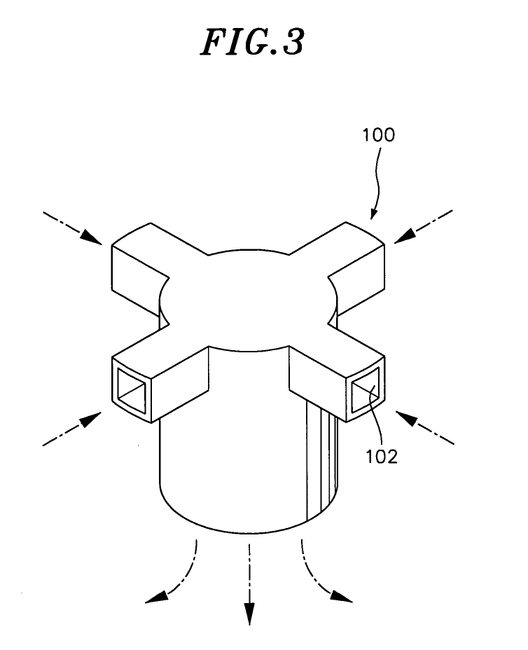

FIG. 2 is a cross sectional view of a wet type air cleaner in accordance with a first preferred embodiment of the present invention, and FIG. 3 shows a perspective view of a guide block of the air cleaner.

As shown in FIG. 2, the wet type air cleaner in accordance with the first preferred embodiment of the present invention includes a housing 50 provided with a plurality of, e.g., four, air suction ports 52 and an air outlet 54, the housing 50 storing cleaning water in a bottom portion thereof; a blower unit 60 for suctioning indoor air through the air suction ports 52 and dispersing the cleaning water to the air passing therethrough; a guide block 100 for guiding the indoor air suctioned through the air suction port toward the cleaning water in the bottom portion of the housing 50; a pumping unit 70 for pumping up the cleaning water stored in the housing 50 to the blower unit 60; a fist purification unit 80 for capturing large-size particles contained in the air and dispersing moisture in the air; and a second purification unit 90 for directing downward the air flowing in the guide block 100 to the cleaning water in the bottom portion of the housing 50 and for drawing up and dispersing radially the cleaning water in the bottom portion of the housing 50 to allow the air directed downward to contact with the dispersed cleaning water.

The housing 50 is of, e.g., a cylindrical shape. The air outlet 54 is provided at the upper wall of the housing 50, and the air suction ports 52 are provided at the sidewall of the housing 50. A filter unit 56 is installed between the air outlet 54 and the blower unit 60 to prevent the cleaning water from being discharged together with the air through the air outlet 54.

As shown in FIG. 3, the guide block 100 is formed in, e.g., a cylindrical shape with an opened bottom end portion, wherein the diameter of the guide block is smaller than that of the housing 50. Formed on the top end portion of the guide block 100 are a plurality of, e.g., four, air inlets 102 which are extended radially to the outside of the housing 50 through the air suction ports 52. The indoor air introduced via the air inlets 102 is guided toward the bottom end of the guide block 100 to contact the cleaning water stored in the bottom portion of the housing 50. Then, the air flows upward along an air flow path formed between the outer wall of the guide block 100 and the inner wall of the housing 50, and is discharged to the outside via the air outlet 54.

The blower unit 60 is installed on a rotation shaft 58, which is rotated by a motor 69, between the outlets 54 and the guide block 100. The blower unit 60 includes a multifunctional fan 62 provided with a fan main body 67 fixedly installed on the rotation shaft 58 and a plurality of blades 66 formed at the outer peripheral surface of the fan main body 67, for directing air in the housing 50 to the outside through the air outlet 54 and also dispersing the cleaning water supplied thereto in radial directions. The motor 69 rotates the rotation shaft 58 and hence the multifunctional fan 62, so that indoor air is introduced through the air inlets 102, flows downward along the guide block 100 and moves upward to be discharged through the air outlets 54. When the rotation shaft 58 is rotated by the motor 69, a drum 82 of the first purification unit 80 and a fan 94a of the second purification unit 90 fixed thereon are also rotated, which will be described later. By the rotation of the multifunctional fan 62, the indoor air is suctioned through the air suction ports 52 into the housing 50.

Each blade 66 is provided with a plurality of guides 68 extending radially on the top surface thereof. The guides 68 allow the cleaning water on the top surfaces of the blades 66 to be dispersed in the radial directions. That is, the guides 68 are formed in curve shapes to conform to the shapes of the blades 66, thus facilitating the dispersion of the cleaning water.

Further, a water storage portion 65 is concavely formed in the fan main body 67, for storing therein the cleaning water supplied thereto by the pumping unit 70. A number of water spray holes 64 are formed in the sidewall of the water storage portion 65, for spraying the cleaning water stored in the water storage portion 65 in the radial directions by a centrifugal force generated by the rotation of the fan main body 67.

The pumping unit 70 includes a water supply line 72 whose lower end is located near the bottom portion of the housing 50 to be submerged in the cleaning water and whose upper end is positioned above the multifunctional fan 62; and a pump 74 installed on the water supply line 72 to pump up the cleaning water stored in the bottom portion of the housing 50 so that the cleaning water is supplied onto the multifunctional fan 62.

Furthermore, the first purification unit 80 has a drum 82 fixed on the rotation shaft 58, the drum 82 having a cylindrical shape with an open top and a closed bottom; and a collecting member 86 slantingly extended from the sidewall of the guide block 100 toward the drum 82 so as to guide large-size particles and moisture in the air suctioned through the air inlets 102 to be collected in the drum 82. A number of discharge holes are formed in the sidewall of the drum 82.

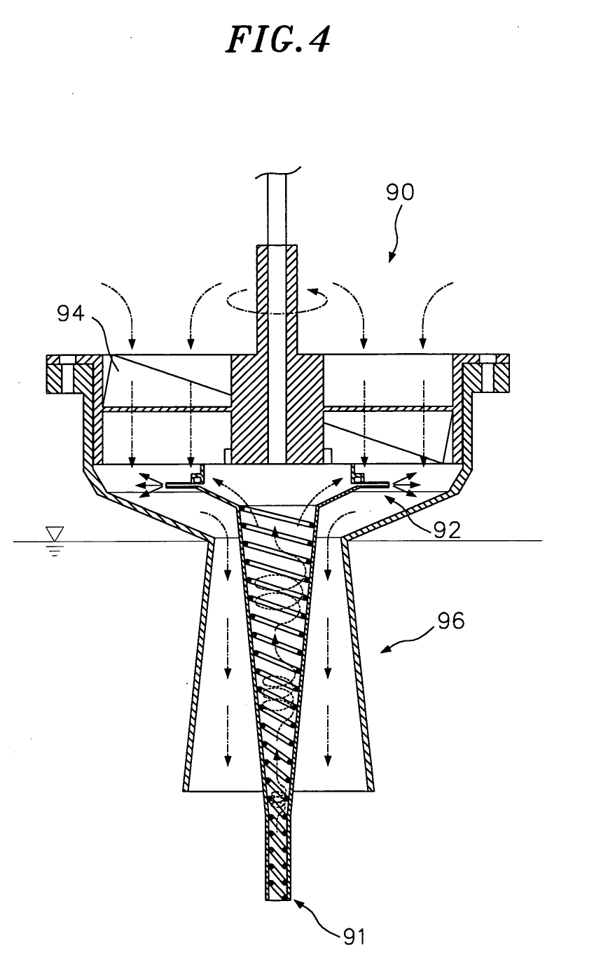

Referring to FIG. 4, the second purification unit 90 includes an inner guide portion 91 whose bottom end is submerged in the cleaning water; a water spray portion 92 provided on the upper end of the inner guide portion 91; a fan 94 for directing the air in the guide block 100 downward; and an outer guide portion 96 installed outside the inner guide portion 91 with a gap formed therebetween to guide the air directed downward by the fan 94 and the dispersed cleaning water into the cleaning water stored in the bottom portion of the housing 50. The second purification unit 90 is fixed on the rotation shaft 58 and is rotated therewith. The inner guide portion 91 has a funnel shape with a wider upper portion and a narrower lower portion such that the cleaning water is drawn upward by a centrifugal force while it rotates.

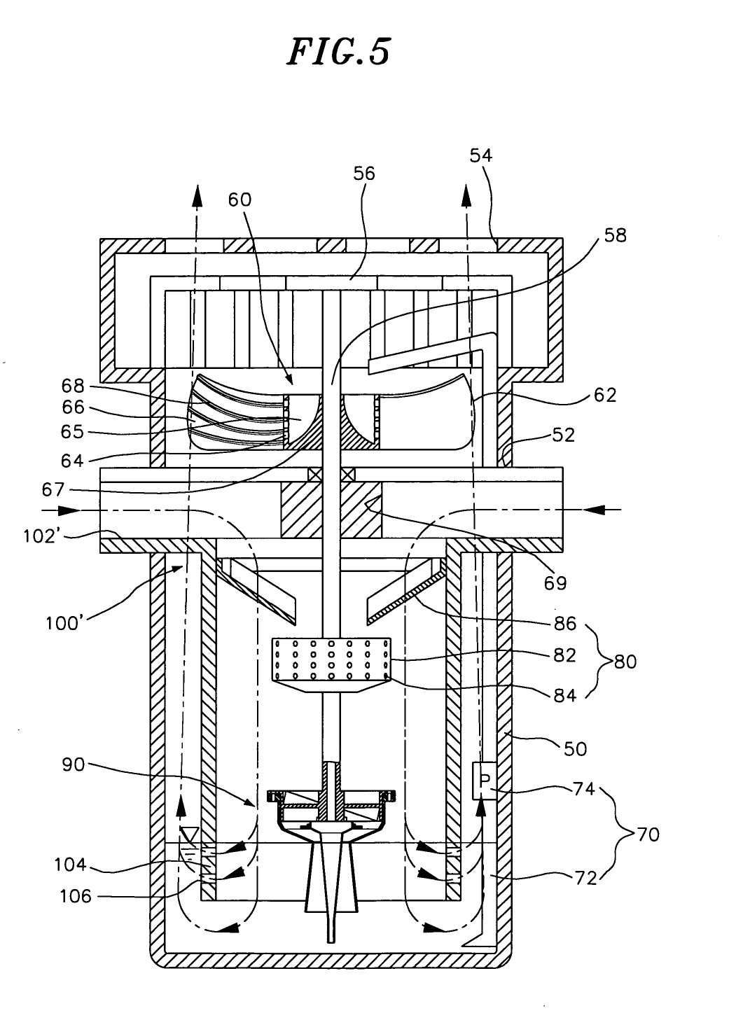

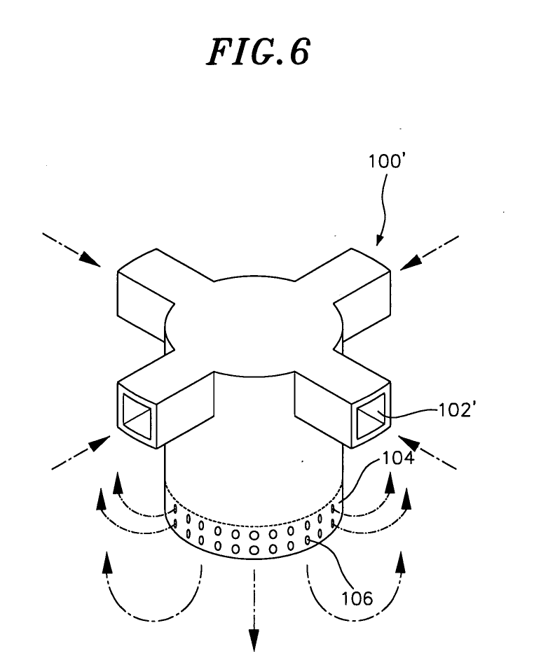

Referring to FIGS. 5 and 6, there is shown a wet type air cleaner in accordance with a second preferred embodiment of the present invention.

The wet type air cleaner of the second preferred embodiment is similar to that of the first preferred embodiment except for the structure of a guide block 100′. Therefore, only the guide block 100′ will be described and like reference numerals represent like parts in the drawings.

As shown in FIGS. 5 and 6, the guide block 100′ is formed in, e.g., a cylindrical shape with an opened bottom end portion 104, wherein the diameter of the guide block 100′ is smaller than that of the housing 50. Formed on the top end portion of the guide block 100′ are a plurality of, e.g., four, air inlets 102′ which are radially extended to the outside of the housing 50 through the respective suction air ports 52. The bottom end portion 104 of the guide block 100′ is extended to be submerged into the cleaning water stored in the bottom portion of the housing 50. A plurality of holes 106 are formed in the lower end portion 104, so that some of the air flowing into the cleaning water along the guide block 100′ passes through the holes 106, thereby suppressing a generation of a large bubble.

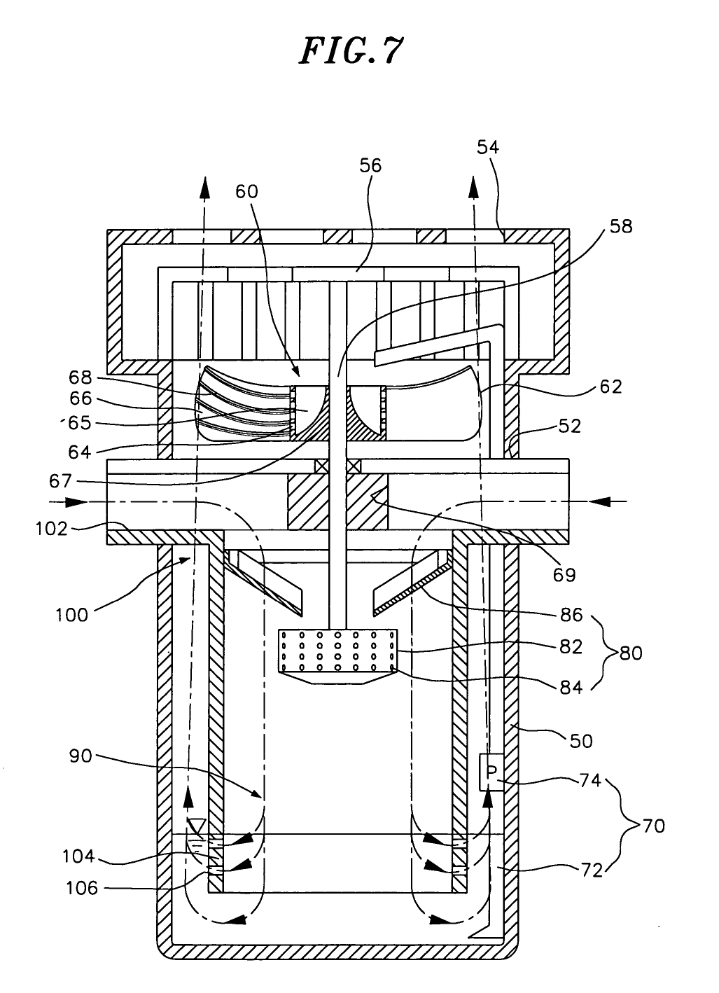

In the second embodiment, the second purification unit 90 may be eliminated as shown in FIG. 7.

The indoor air introduced via the air inlets 102′ is guided to the lower end of the guide block 100′ to flow into the cleaning water stored in the bottom portion of the housing 50. Then, after passing through the cleaning water, the air flows upward along an air flow path formed between the guide block 100′ and the housing 50, and is discharged to the outside via the air outlet 54.

Hereinafter, there will be described an operation of the wet type air cleaner of the present invention.

When the rotation shaft 58 is rotated by the motor 69, the multifunctional fan 62, the drum 82 and the fan 94 are also rotated with the rotation shaft 58, so that the indoor air is suctioned through the air inlets 102 or 102′ into the housing 50. While the suctioned air flows downward along the guide block 100 or 100′, moisture and/or large-size particles contained in the air are collected into the drum 82 by the collecting member 86 and the moisture in the drum 82 is dispersed outwardly by the rotation thereof. The air passing through the first purification unit 80 is directed downward by the rotation of the fan 94 of the second purification unit 90. The air directed by the second purification unit 90 passes through the cleaning water dispersed by the water spray portion 92 of the second purification 90 and flows into the cleaning water stored in the bottom portion of the housing 50. While the air contacts with the cleaning water, foreign materials contained therein are adsorbed by the cleaning water and removed therefrom. The air is then moved upward along the air flow path formed between the guide block 100 or 100′ and the housing 50.

Meanwhile, the cleaning water is pumped up by the pumping unit 70 to be supplied onto the multifunctional fan 62. The cleaning water supplied to the multifunctional fan 62 is dispersed by the rotation thereof. Accordingly, the air moving upward along the air flow path flows through the cleaning water dispersed by the multifunctional fan 62 to be discharged through the air outlets 54 to the outside. At this time, the dispersed cleaning water contacts with the air to adsorb noxious substance contained in the air. Further, by colliding with the inner surface of the housing 50, the dispersed cleaning water generates negative ions which are discharged to the outside together with the air.

In accordance with the wet type air cleaner described above, since multiple purification units are provided within the housing, the number of the contact between the air and the cleaning water is increased, resulting in an improved removal efficiency of foreign materials from the air. Furthermore, since the number of components of the air cleaner is reduced and the structure thereof is simplified, time and costs required for the fabrication of the air cleaner can be lowered, resulting in reduction of manufacturing cost.

Moreover, by installing the guide block for guiding the air to flow downward toward the cleaning water stored in the bottom of the housing, it is possible to make a larger amount of air contact with the cleaning water stored in the bottom of the housing, thereby increasing the purification efficiency.

While the invention has been shown and descried with respect to the preferred embodiments, it will be understood by those skilled in the art that various changes and modifications may be made without departing from the spirit and scope of the invention as defined in the following claims.

What is claimed is:

1. A wet type air cleaner comprising:
a housing with an air suction port and an air outlet, the housing storing cleaning water in a bottom portion thereof;
a blower unit for dispersing the cleaning water and allowing air to be introduced through the air suction port into the housing and to pass through the dispersed cleaning water, the blower unit being fixed on a rotation shaft of a driving unit to be rotated therewith;
a guide block for guiding the air introduced through the air suction port to flow toward the cleaning water stored in the bottom portion of the housing;
a pumping unit for supplying the cleaning water stored in the bottom portion of the housing to the blower unit to be dispersed thereby.

2. The air cleaner of claim 1, further comprising: a first purification unit for collecting and dispersing moisture contained in the air introduced through the air suction port.

3. The air cleaner of claim 2, wherein the first purification unit includes a drum fixed on the rotation shaft, the drum having a plurality of holes; and a collecting member for guiding moisture in the air introduced through the air inlet port into the drum.

4. The air cleaner of claim 1, further comprising: a second purification unit, installed on the rotation shaft, for drawing up and dispersing the cleaning water stored in the bottom portion of the housing and directing the air introduced through the air suction port to flow through the dispersed cleaning water into the cleaning water stored in the bottom portion of the housing.

5. The air cleaner of claim 4, wherein the second purification unit includes an inner guide portion whose bottom end is submerged in the cleaning water stored in the bottom portion of the housing; a water spray portion provided on the upper end of the inner guide portion; a fan for directing the air in the guide block downward; and an outer guide portion installed outside the inner guide portion with a gap formed therebetween to guide the air directed downward by the fan and the dispersed cleaning water into the cleaning water stored in the bottom portion of the housing, the inner guide portion having a wider upper portion and a narrower lower portion such that the cleaning water is drawn upward by a centrifugal force while it rotates.

6. The air cleaner of claim 1, wherein the pumping unit includes a water supply line whose lower end is located in the cleaning water stored in the bottom portion of the housing and whose upper end is positioned above the blower unit; and a pump installed on the water supply line to pump up the cleaning water stored in the bottom portion of the housing so that the cleaning water is supplied onto the blower unit.

7. The air cleaner of claim 1, further comprising: a filter unit, disposed between the air outlet and the blower unit, for preventing the cleaning water dispersed by the blower unit from being discharged through the air outlet together with the air, wherein the air outlet and the air suction port are formed in a top and a side wall of the housing, respectively.

8. The air cleaner of claim 1, wherein the guide block is formed in a cylindrical shape with an opened bottom end portion of a diameter smaller than that of the housing, and has an air inlet formed on a top end portion of the guide block, the air inlet extending radially to the outside of the housing through the air suction port of the housing, so that the air is introduced through the air inlet into the housing.

9. The air cleaner of claim 1, wherein the guide block has an opened bottom end portion which is submerged in the cleaning water stored in the bottom portion of the housing.

10. The air cleaner of claim 8, wherein the opened bottom end portion of the guide block is extended to be submerged in the cleaning water stored in the bottom portion of the housing.

11. The air cleaner of claim 9, wherein a plurality of holes are formed in the bottom end portion.
